(19) United States
(12) Patent Application Publication
(10) Pub. No.: US 2015/0382270 A1
(43) Pub. Date: Dec. 31, 2015

(54) Determination of Whether a Handover was necessary Based on Quality of Service

(71) Applicant: NOKIA SOLUTIONS AND NETWORKS OY, Espoo (FI)

(72) Inventors: Krzysztof KORDYBACH, Pulawy (PL); Malgorzata TOMALA, Wroclaw (PL)

(73) Assignee: Nokia Solutions and Networks Oy, Espoo (FI)

(21) Appl. No.: 14/768,566

(22) PCT Filed: Feb. 19, 2013
(86) PCT No.: PCT/EP2013/053219

§ 371 Date: Aug. 18, 2015

(51) Int. Cl. H04W 36/30; H04W 36/14; H04L 12/26; H04L 12/24

(52) U.S. Cl. CPC H04W 36/30; H04L 41/5019; H04W 36/14; H04L 43/0888; H04L 43/16

(57) ABSTRACT

Methods, apparatuses and computer program products are provided, wherein an indication is provided to a second network entity from a first network entity to monitor a quality of service provided to a user equipment handed over from the first network entity to the second network entity. The second network entity monitors the quality of service provided to the user equipment and generates a corresponding indication. The indication of the quality of service provided to the user equipment by the second network entity is then provided by the second network entity to the first network entity. Based on the received indication of the quality of service, a determination as to whether a handover was necessary is made by the first network entity.

The present application relates to the determination of an unnecessary handover and in particular, but not exclusively to, an inter-radio access technology handover.

A communication system can be seen as a facility that enables communications between two or more entities such as a communication device, e.g. mobile stations (MS) or user equipment (UE), and/or other network elements or nodes, e.g. a Node B, enhanced Node B (eNB) or base transceiver station (BTS), associated with the communication system. A communication system typically operates in accordance with a given standard or specification which sets out what the various entities associated with the communication system are permitted to do and how that should be achieved.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS).

A mobile communication network may logically be divided into a radio access network (RAN) and a core network (CN). The core network entities typically include various control entities and gateways for enabling communication via a number of radio access networks and also for interfacing a single communication system with one or more communication systems, such as with other wireless systems, such as a wireless Internet Protocol (IP) network, and/or fixed line communication systems, such as a public switched telephone network (PSTN).

The radio access network may provide a connection between the core network (CN) and a device such as a user equipment (UE) and implements a radio access technology. Examples of radio access networks may comprise the UMTS terrestrial radio access network (UTRAN), the GSM/EDGE radio access network (GERAN) and/or E-UTRAN for long term evolution (LTE). The radio access network may include entities such as a base station, node B, enhanced node B and/or a radio network controller (RNC).

A handover of a user equipment or mobile station may occur when a user equipment is in the coverage area of two different access points (for example a base station, node B or eNodeB) of a radio access network. Different radio access technologies may be deployed in different geographical areas. A handover may therefore occur between different access points supporting different radio access technologies.

According to a first aspect, there is provided a method carried out by a first network entity comprising: providing an indication to a second network entity to monitor a quality of service provided to a user equipment handed over from the first network entity to the second network entity; receiving an indication of the quality of service provided to the user equipment by the second network entity; and determining whether a handover was necessary based on the received indication.

The indication to monitor the quality of service comprises an indication to measure a quality of service metric of a service provided to the user equipment by the second network entity. The quality of service metric is a scheduled IP throughput. The first network entity operates in accordance with a first radio access technology and the second network entity operates in accordance with a second radio access technology. The indication indicates at least one of: the quality of service is below a threshold; and the quality of service is above a threshold.

The method may further comprise: determining that the handover was unnecessary when the indication indicates that the quality of service is below the threshold. The threshold corresponds to one of: a quality of service that would have been provided to the user equipment if the user equipment had not been handed over; and a minimum predefined quality of service.

The method may further comprise: estimating a quality of service corresponding to the quality of service that the first network entity would have provided to the user equipment if the user equipment had not been handed over. The method may further comprise: providing the estimated quality of service to the second network entity. The method may further comprise: comparing the indication of the quality of service with the estimated quality of service to determine whether handover was necessary.

According to a second aspect, there is provided a method carried out by a second network entity comprising: monitoring a quality of service provided to a user equipment handed over from a first network entity to the second network entity in response to an indication from the first network entity; generating an indication of the quality of service provided to the user equipment by the second network entity; and providing the indication to the first network entity.

The monitoring comprises measuring a quality of service metric of a service provided to the user equipment by the second network entity. The quality of service metric is a scheduled IP throughput. The first network entity operates in accordance with a first radio access technology and the second network entity operates in accordance with a second radio access technology.

Generating the indication of the quality of service may comprise comparing the monitored quality of service to a threshold. Generating the indication of the quality of service may further comprise indicating at least one of: the quality of service is below a threshold; and the quality of service is above a threshold.

The threshold may correspond to one of: a quality of service that would have been provided to the user equipment if the user equipment had not been handed over; and a minimum predefined quality of service.

The method may further comprise: receiving an estimated quality of service corresponding to the quality of service that the first network entity would have provided to the user equipment if the user equipment had not been handed over. Generating an indication of the quality of service may comprise determining a minimum monitored quality of service.

According to a third aspect, there is provided an apparatus comprising a processor and at least one memory configured to carry out the steps of: monitoring a quality of service provided to a user equipment handed over from a first network entity to the apparatus in response to an indication from the first network entity; generating an indication of the quality of service provided to the user equipment by the apparatus; and providing the indication to the first network entity.

According to a fourth aspect, there is provided an apparatus comprising a processor and at least one memory configure to carry out the steps of: providing an indication to a second network entity to monitor a quality of service provided to a user equipment handed over from the apparatus to the second network entity; receiving an indication of the quality of service provided to the user equipment by the second network entity; and determining whether a handover was necessary based on the received indication.

According to a fifth aspect, there is provided a computer program product comprising program instructions, when executed, performing the steps of: monitoring a quality of service provided to a user equipment handed over from a first network entity to the apparatus in response to an indication from the first network entity; generating an indication of the quality of service provided to the user equipment by the apparatus; and providing the indication to the first network entity.

According to a sixth aspect, there is provided a computer program product comprising program instructions, when executed, performing the steps of: providing an indication to a second network entity to monitor a quality of service provided to a user equipment handed over from the apparatus to the second network entity; receiving an indication of the quality of service provided to the user equipment by the second network entity; and determining whether a handover was necessary based on the received indication.

The handover may be between an access point of a first radio access technology and an access point of a second radio access technology. Alternatively the handover may be between a pico cell and a macro cell of a first access technology. The pico cell may provide a coverage area within a coverage area of the macro cell. In some embodiments the macro cell may be an access point of a network and the pico cell may be a repeater cell for that access point.

Embodiments of the present application may be described with reference to the following figures in which:

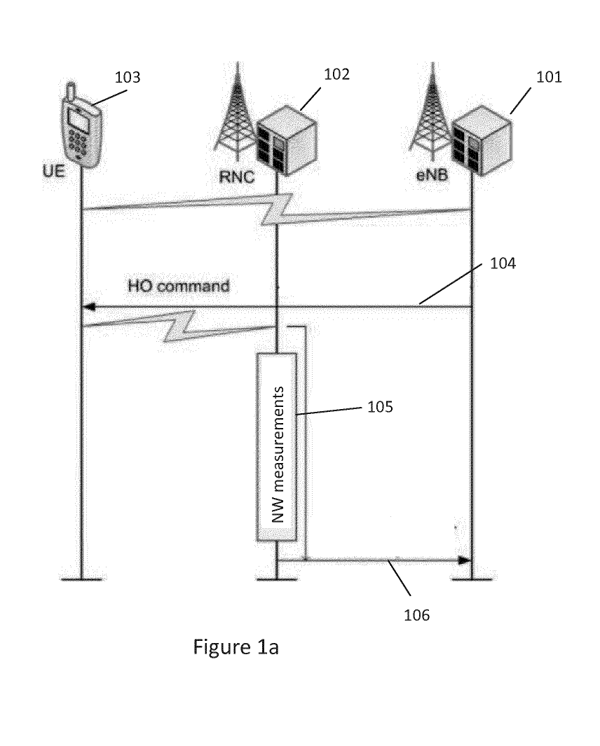

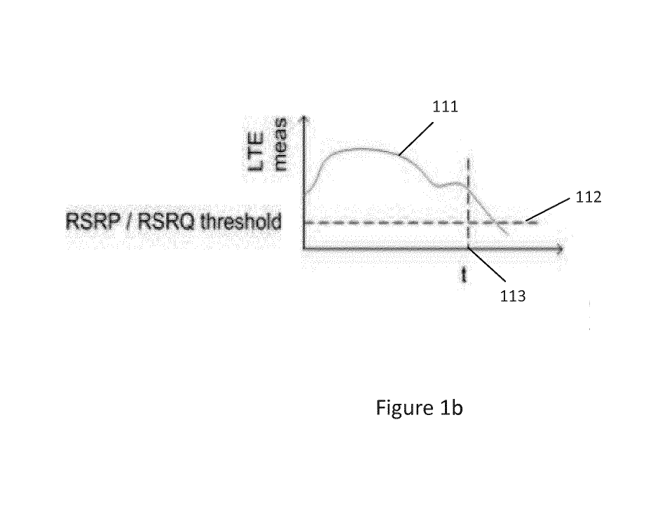

FIG. 1 shows an example of an inter-radio access technology handover;

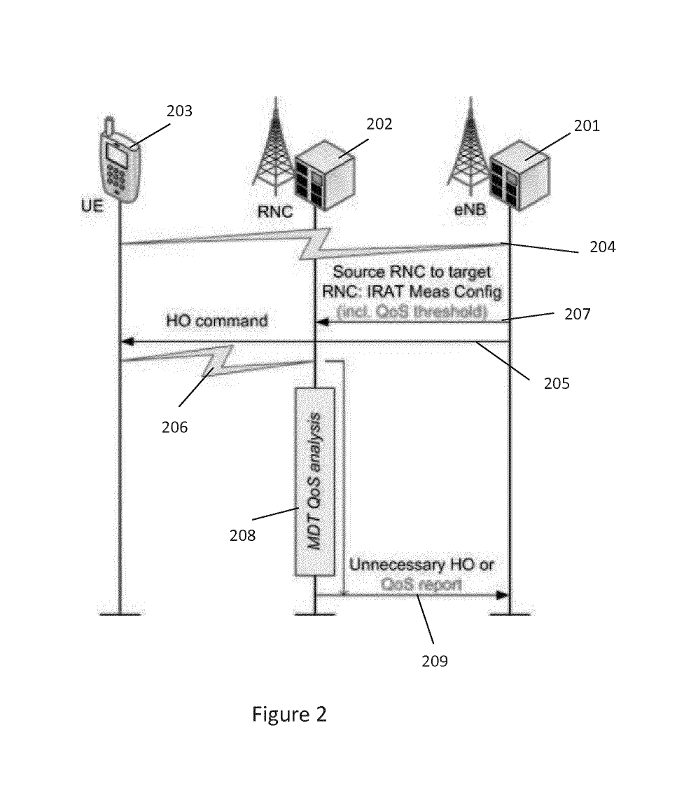

FIG. 2 shows an example of a handover in which quality of service experience by a user is monitored;

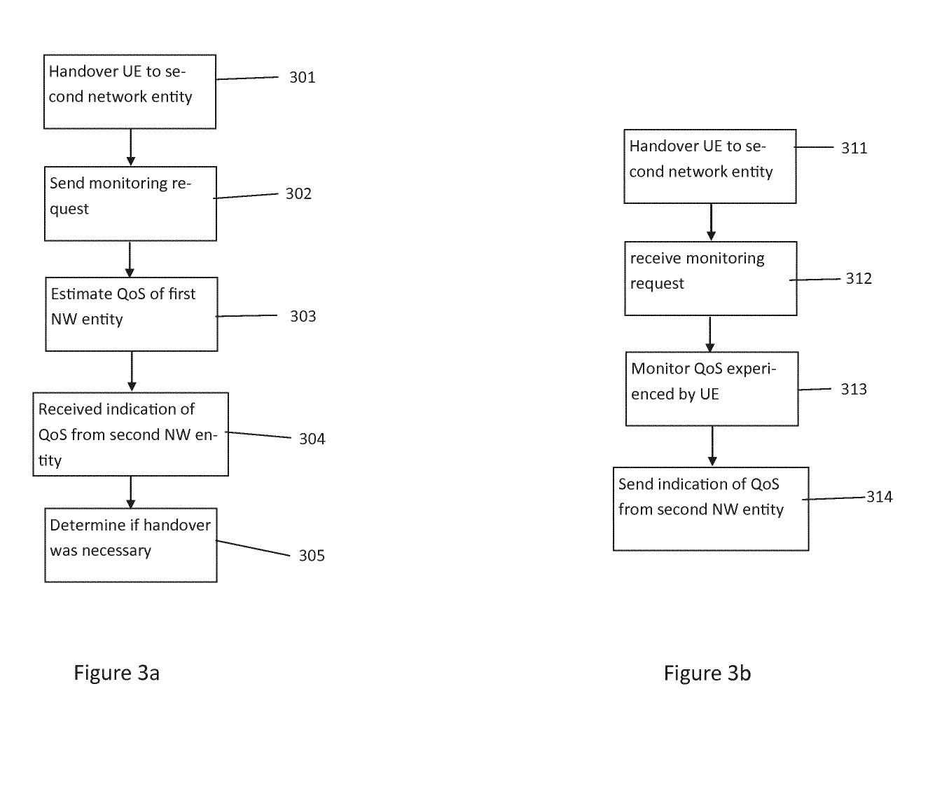

FIGS. 3a and 3b depict respective flow diagrams indicating the method steps carried out by network entities of some embodiments;

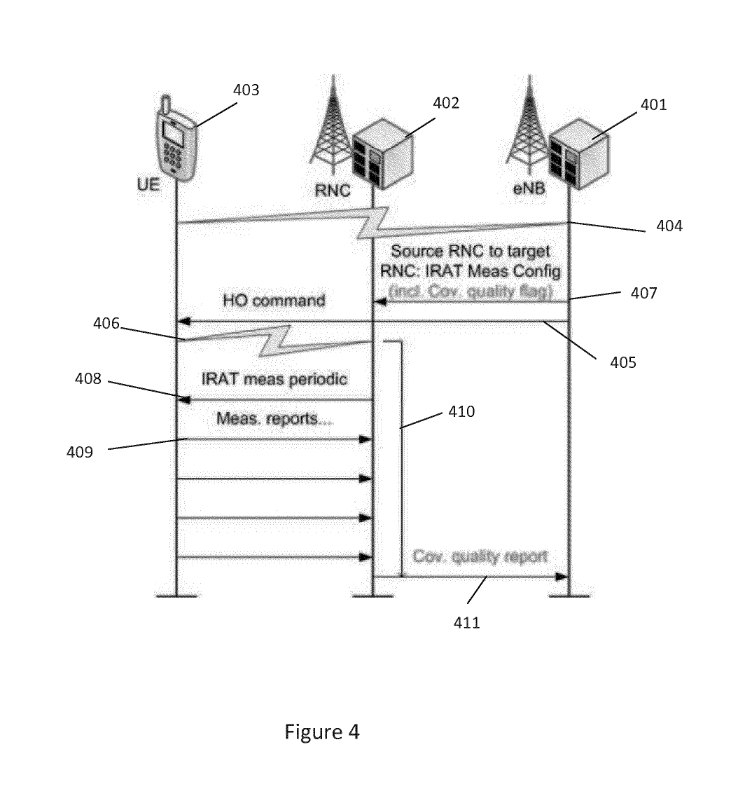

FIG. 4 shows an example of a handover in which coverage of surrounding cells is monitored;

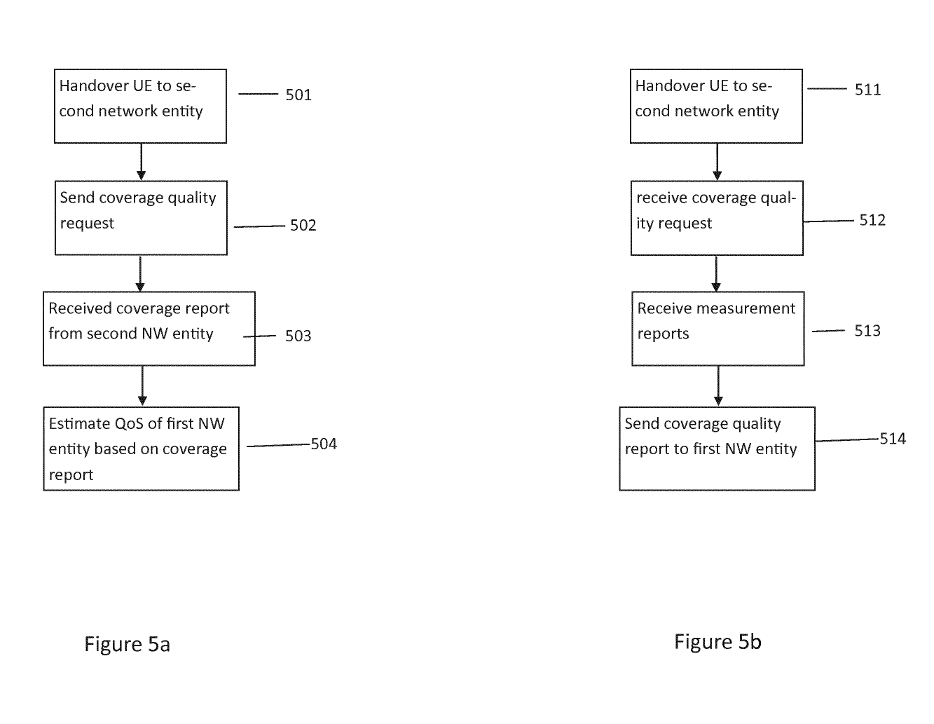

FIGS. 5a and 5b depict respective flow diagrams indicating the method steps carried out by network entities of some embodiments;

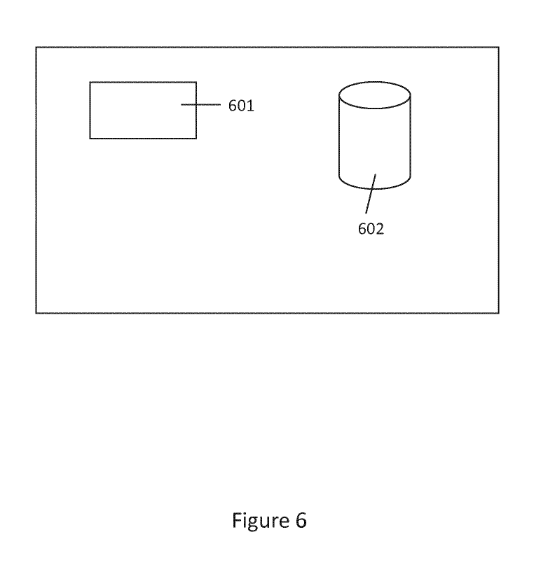

FIG. 6 is a schematic diagram showing an example of a network entity in accordance with some embodiments.

Self-optimising networks exist in which a network may learn from its current behaviour to optimise future behaviour. One of the features of a self-optimising network is the detection of an unnecessary handover of an user equipment from one radio access technology (RAT) to another. For example, the unnecessary handover of an user equipment from an LTE network access point to an access point supporting UTRAN may be detected. For example an eNodeB supporting LTE may be provided with information from which it can determine whether an inter-RAT handover from LTE to UTRAN was necessary.

FIGS. 1a and 1 b show an example of such a handover. FIG. 1a comprises a first network entity 101, a second network entity 102 and an user equipment 103. The user equipment 103 may be in an area of an overlap in the coverage of a first cell by the first network entity 101 and a second cell by the second entity 102. The user equipment may be on the border between the coverage area of the first cell and the second cell. It will be appreciated that the target (second) cell may provide coverage beyond the border of the first cell coverage area however the target cell may not be able to maintain a service at the same quality of service (QoS) level beyond that border

A decision may be made to hand the user equipment 103 over from the first network entity 101 to the second entity 102. This handover command is shown at 104. The first network entity 101 may support a first radio access technology and the second network entity 102 may support a second radio access technology.

The first network entity 101 may have self-optimising network capabilities and wish to determine whether the handover of the user equipment 101 was necessary. The first network entity 101 may request that the second network entity 102 and handed over user equipment 103 carry out measurements to aid in this determination. These measurements may be measurements of the signal coverage provided by the first network entity 101 measured by the user equipment 103. For example, the user equipment may measure the strength of signal provided by the first network entity 101 and provide this to the second network entity 102.

In some embodiments, the measurements may be reference signal received power (RSRP) and/or reference signal received quality (RSRQ) measurements. These measurements may relate to a quality or a strength of a signal of the first network entity 101 that the user equipment can pick up. In other words, the measurements may pertain to the signal strength of the first radio access technology that a user would have experienced had the user equipment 103 not been handed over. These measurements are shown at 105. The second network entity may provide information relating to the measurements to the first network entity 101 at 106.

In one embodiment, the first network entity 101 may be an eNodeB supporting an LTE radio access network and the second network entity 102 may be a radio network controller of a UTRAN. It will be appreciated that the radio network controller 102 may support one or more access points, for example nodeBs, one or more of which may be in communication with the user equipment.

The eNodeB 101 may request the radio network controller 102 to configure the handed over user equipment 103 to measure the signal strength and/or quality of a reference signal of the first access technology.

It may then be determined whether handover was necessary. For example, it may be determined whether the reported measurements were above a threshold for the period of time. If the measurements remained above the threshold for a period of time it may be determined that the handover was not necessary. For example, if the first network entity 101 could have provided a signal strength above the threshold for the period of time, it may be determined that the handover was unnecessary. In other words, it may be determined that the signal strength provided by the first network entity or first radio access technology was sufficient to support services used by the user equipment and thus handover was unnecessary.

If the measurements fall below the threshold, it may be determined that the handover was necessary. For example, that the signal strength of the first network entity 101 was not sufficient to support services for the user equipment.

FIG. 1b shows an example of the comparison of the measurements of the signal strength/quality to a threshold.

FIG. 1b plots the measurements made by the user equipment 101 against time. The measurements are shown at 111. The threshold is shown at 112. In this example the threshold relates to an acceptable level for RSRP and/or RSRQ measurements. The measurements 111 may be compared to the threshold 112 for a period of time (t) 113. If the measurements remain above the threshold for the given period of time (t) 113, it may be determined that the handover was not necessary.

It will be appreciated that the threshold and the period of time may be parameters selected by the network in association with the requirements of the user equipment. In some embodiments the selection of the threshold and the time period may correspond to a minimum call quality expected by the user.

The determination of whether a handover was necessary may be carried out by the first network entity 101 or the second network entity 102. In some embodiments where the second network entity carries out the determination, the second network entity 102 may inform the first network entity 201 of the determination using a RAN information management mechanism. In some embodiments, the first network entity may use this information to detect sub-optimal configuration of the network where the LTE coverage is not utilized optimally.

The determination of whether a handover was necessary in FIGS. 1a and 1b is based on a measurement of signal strength and/or signal quality and does not take into account the effective quality of service (QoS) experienced by a user of a user equipment. In some cases in inter-RAT handover, there may be a discrepancy between the measured radio signal and actual service perception, i.e. user experience following a handover.

For example a user's perception of network quality may be based on more than basic radio coverage requirements (to provide good coverage for making and receiving a basic voice call) and may take the quality of the network with respect to data services into account.

For example, a situation may exist where a user is connected to a data service and enjoying, for example, 400 kbps throughput. The connection is initiated at an LTE radio access network entity, but when approaching a border between LTE cells, the user is handed over to UTRAN radio access network. Unnecessary handover analysis may be requested and RSRP/RSRQ levels may be defined for slightly lower throughput, e.g. 300 kbps transmission.

In this case, the throughput in UTRAN may drop to 100 kbps. The LTE signal strength/quality measured by the user equipment may drop below the RSRP/RSRQ threshold and therefore the handover may be considered necessary. However the user may be experiencing lower data throughput than the user would have had handover not occurred. The LTE coverage would have been continuous and may have provided higher throughput.

Embodiments of the present application may provide means to take into account an indication of the QoS experienced by a user after handover when determining whether a handover was necessary. In some embodiments, an indication of the quality of service experienced by a user after handover is compared to a threshold for the QoS in the determination. In some embodiments the indication of the QoS experienced by a user after handover and an estimate of the QoS that would have been experienced has handover not occurred are used to determine whether the handover is necessary. The estimate may be for example generated from QoS measurements made by a user equipment before handover, a cell load of the source cell, based on inter-RAT signal strength measurements and/or be a predetermined threshold.

FIG. 2 shows an example of a determination of unnecessary handover in accordance with some embodiments. FIG. 2 comprises a first network entity 201, a second network entity 202 and an user equipment 203. The first network entity may support a first radio access technology and the second network entity may support a second radio access technology.

The user equipment 203 may initially be in communication with the first network entity 201 over the first radio access technology. This is shown at 204. It may be determined to hand over the user equipment 203 from the first radio access technology to the second radio access technology. The first network entity and radio access technology may be considered the respective source network entity and radio access technology. The second network entity and radio access technology may be considered the respective target network entity and radio access technology.

The handover command may be sent for example from the first network entity 201 to the user equipment 203 at 205. It will be appreciated that this is by way of example only and other handover signalling may take place. After handover, the user equipment 203 may be in communication with the second network entity 202 for example via a network access point associated with the second network entity 202. This is shown at 206.

The first network entity 201 may wish to determine whether the handover was necessary. The first network entity 201 may configure the second network entity 202 to provide information relating to whether or not the handover was necessary. This configuration may include an indication or request 207 for the second network entity 202 to monitor the QoS experienced by the user equipment 203 after being handed over. The QoS experienced by the user equipment 203 after handover is monitored at 208.

The monitoring 208 may comprise receiving measurements corresponding to one or more QoS metrics. The QoS metrics may be for example metrics relating to a perceived quality of service at the user equipment. For example the QoS metric may be for example the scheduled IP throughput. Other examples of QoS metrics may be data volume, latency and/or allocated bit numbers.

The second network entity 202 may provide information relating to the monitored QoS metrics to the first network entity 201 at 209. The monitored QoS metric may be used to determine whether or not the handover was necessary.

In one embodiment, the second network entity 202 may provide an indication of the worst measurement for the QoS metric carried out in the time period. In this embodiment, the first network entity 201 may compare the indicated worst QoS metric measured from the second network entity 202 to an estimated value of the QoS metric that the first network entity 201 would have provided if handover did not occur. This estimated value may be generated using measurements made by the user equipment 203 while it was in communication with the first network entity 201. Alternatively, the estimate may be generated based on inter-RAT measurements made by the handed over user equipment 203, for example signal strength measurements for the signal strength provided by the first network entity 201. In these embodiments, the estimate may additionally be generated based on the cell load of the first network entity.

In another embodiment, the second network entity 202 may compare the measurements of the QoS metric against a threshold and generate a report if a measurement falls below or does not fall below the threshold. The threshold may be predetermined threshold corresponding to an acceptable value for the QoS metric in some embodiments. In other embodiments the threshold may correspond to an estimate of the QoS metric that the first network entity 201 would have provided had had the user equipment not been handed over. If the measured QoS metric falls below the threshold, it may be determined that the handover was unnecessary. If the measured QoS metric does not fall below the threshold, then it may be determined that the handover was necessary. In some embodiments, the measurement of the QoS experienced by the user equipment 203 may be based on minimisation of drive test (MDT) QoS related measurements.

MDT is a method of monitoring network performance from user's perspective after the network is operational. In MDT user equipment may collect radio measurements over a geographical area to provide analysis of the signal coverage. Also the serving eNB or RNC may perform UE-specific measurements to provide analysis of service perception by user equipment. The measurements may then be transferred to operation and maintenance (OAM) and may then be used to optimise parameters of the network.

MDT provides QoS measurements. The QoS measurements defined for MDT may relate to detecting QoS related problems and end-user satisfaction assessment. Network nodes of a radio access network (for example the eNodeB and RNC) may measure QoS metrics such as scheduled IP throughput and/or data volume for a UE. In some embodiments, the second network entity 202 may implement QoS analysis based on the MDT measurements.

The QoS metric measurements may be carried out when an OAM requests them to be carried out in relation to a network entity. A network node may receive an MDT trigger or configuration from an OAM and start carrying out the measurements. In embodiments of the present application these measurements may be triggered by a network node such as the first network entity 201. The measurements may be carried out in accordance with MDT configuration but may be used to determine unnecessary handover. For example, the measurements may be standardised according to MDT.

FIG. 3a shows the method steps carried out by the first network entity 201 in some embodiments.

At step 301 of FIG. 3a, a user equipment 203 may be handed over from the first network entity 201 to the second network entity 202. At step 302, the first network entity 201 may additionally send a request for the monitoring of QoS experienced by the user equipment 203 while being served by the second network entity 202.

In some embodiments, the request may be indicated by adding a quality of service criteria information element (IE) to a configuration message from the first network entity 201 to the second network entity 202, or a flag may be set indicating a selected quality of service parameter or QoS metric is to be measured and reported. In some embodiments this message may be an inter-radio access technology (IRAT) measurement configuration. The IRAT measurement configuration may form part of a source RNC to target RNC transparent container message. In some embodiments the QoS metric to be measured may be explicitly identified, in other embodiments, the identity may be implicit.

The request at 302 may cause the second network entity 202 to start monitoring the QoS metric measured by the user equipment 203.

At step 303, the first network entity 201 may estimate the quality of service based on data throughput and/or a selected quality of service parameter that the user equipment 203 would have experienced had not been handed over to the second network entity 202. In other words, the first network entity 201 may estimate the data throughput or other quality of service perception that would have been experienced by a user equipment 203 if it was still being serviced by the first network entity 201. In other embodiments, the estimate may be a predetermined value.

It will be appreciated that step 303 may be optional. In embodiments where threshold at the second network entity 202 is predetermined, this estimation may not be carried out. In some embodiments, where the threshold is based on an estimated QoS that may be provided by the first network entity 201, the first network entity 201 may provide this estimate to the second network entity to be used as the threshold.

In some embodiments the first network entity 201 may estimate the quality of service based on previous measurements made by the user equipment 203 when it was being served by the first network entity 201 as well as the cell load of the first network entity 201. In an alternative embodiment, an additional request (in the same message or as a separate signalling) may be sent to the second network entity 202 and the user equipment 203 for the user equipment 203 to carry out inter-radio access technology measurements of the signal coverage quality, for example RSRP and/or RSRQ levels, from the first network entity 201. This signal coverage quality measurement may be used to estimate the QoS that may be provided by the first network entity 201.

At step 304, the first network entity 201 may receive an indication of the measured QoS from the second network entity 202. The second network entity 202 may report an indication of the measured QoS metrics in a variety of ways.

In one embodiment the second network entity 202 may monitor the selected QoS metric measurements for a period of time, for example a running timer, and determine whether these measurements drop below a defined threshold. If a QoS metric measurement drops below this threshold, the second network element 202 may generate a report to the first network element 201.

In other embodiments the second network element 202 may record periodic measurements of the QoS metrics and, at the end of the period of time, may report the lowest quality measurement during that measurement period. In an alternative or additional embodiment the second network element 202 may report that a QoS metric measurement did not drop below a threshold.

At step 305, the first network entity 201 may determine whether the handover was necessary based on the received indication from the second network entity 202 received at step 304.

In the embodiment where the second network entity compares the measured QoS metrics against a threshold, an indication that a QoS measurement fell below the threshold may cause the first network entity to determine that handover was unnecessary. Similarly, an indication that the QoS measurements did not fall below the threshold may cause the first network entity 201 to determine that handover was necessary.

In the embodiment where the lowest measured QoS was reported, the first network entity 201 may compare the received indication (the lowest QoS measurement) against the QoS estimate. If the lowest QoS measurement is greater than the QoS estimate then it may be determined that the handover was necessary. If the lowest QoS measurement is less than than the QoS estimate then it may be determined that the handover was unnecessary.

It will be appreciated that in addition to the quality of service metric(s), e.g. data throughput, embodiments may also use the signal strength measurement as described in relation to FIGS. 1a and 1b in order to determine whether handover was unnecessary.

FIG. 3B shows the method steps that may be carried out by a target network entity, for example a second network entity 202.

At step 311 the user equipment 203 is handed over from the first network entity 201 to the second network entity 202. The second network entity 202 may then receive a request from the first network entity 201, requesting that a QoS metric is to be monitored. This is done at step 312.

In response to this request, the second network entity 202 may monitor the QoS experienced by the user equipment 203 being serviced by the second network entity 202. In some embodiments this may be done by carrying out MDT measurements. However instead of reporting the MDT monitoring to an operation and maintenance entity, the second network entity 202 may report the MDT measurements corresponding to the one or more QoS metrics to the first network entity 201.

As described in relation to FIG. 3A, the second network entity 202 may report these measurements by determining whether the QoS metric drops below a threshold during a period of time and informing the first network entity 201 if the QoS does drop below the threshold and/or the QoS metric does not drop below the threshold. In another embodiment, the worst or lowest measured QoS metric is reported to first network entity 201.

This report or indication of the quality of service is sent from the second network entity 202 to the first network entity 201 step 314.

As described in relation to FIG. 3a, the first network entity 201 may estimate the QoS that would have been provided to a user equipment 203 based on measurements made by the user equipment 203 while the user equipment 203 was being served by the first network entity 201 as well as the cell load of the first network entity 201. In further embodiments, the first network entity 201 may request that the user equipment 203 after handover makes measurements of the signal coverage quality of the first network entity 201 and report this to the first network entity 201. This embodiment is described in relation to FIGS. 4, 5a and 5b.

FIG. 4 shows a first network entity 401, a second network entity 402 and an user equipment 403. The user equipment 403 may be communicating in the radio access network via the first network entity 401 and shown at 404. The user equipment 403 may then be handed over from the first network entity 401 to the second network entity 402. This may be done via a handover command 405. The user equipment 403 may then be serviced by the second network entity 402 in accordance with a second radio access technology. The user equipment 403 may then be in communication with the second network entity 402 shown at 406. It will be appreciated that this may be similar to the handovers described in relation to other embodiments.

In the embodiment of FIG. 4, the first network entity 401 may provide an indication to the second network entity 402 indicating that the user equipment 402 is to make inter-radio access technology measurements after handover. In particular, the first network entity 401 may request that the user equipment 403 carries out coverage quality reporting on the coverage of the first radio access network provided by the first network entity 401. The coverage quality reporting may comprising measuring signal strength/quality of the source network entity, for example making RSRP/RSRQ measurements.

This indication may be send at 407. In some embodiments, the indication may form part of a configuration message from the first network entity 401 to the second network entity 402. For example a flag may be set in an IRAT measurement configuration which may be part of the source RNC to target RNC transparent container.

The second network entity 402 may indicate to the user equipment 403 that such measurements are to be carried out at 408. The user equipment 403 may then carry out the measurement reports. For example the user equipment may generate periodic measurement reports 409 and provide these to the second network entity 402.

In some embodiments, such reporting may take place for a period of time 410. At the end of the time period, the second network entity 402 may provide an indication of the measurements to the first network entity 401. In some embodiments, the second network entity 402 may monitor the measurements against the threshold and generate a report to the first network entity indicating that the measurements dropped below the threshold hold and/or that the measurements did not drop below the threshold. In other or additional embodiments, the second network entity may report the lowest measurement to the first network entity 401. The reporting of a measurement indication from the second network entity 402 to the first network entity 401 is shown at 411.

FIG. 5a is an example of the method steps that may be carried out by the first network entity 401 in accordance with some embodiments.

At step 501 of FIG. 5a, the user equipment 403 is handed over from the first network entity 401 to the second network entity 402. The first network entity 401 may send a coverage quality reporting request to the second network entity 402 at step 502. It will be appreciated that while the step 502 is shown as being carried out after the handover at step 501, in some embodiments the first network entity 401 may request coverage quality measurements to be carried out during or prior to the handover.

At step 503, the first network entity 401 may receive an indication of the coverage quality measurements from the second network entity 402. As discussed, this indication may, for example, be an indication that one or more of the measurements dropped below a threshold, an indication that none of the measurements dropped below the threshold and/or an indication of the lowest measurement.

At step 504 the first network entity 401 may use the indication received from the second network entity 402 to estimate a QoS the user equipment 403 would have experienced had it not been handed over from the first network entity 401 to the second network entity 402. This estimation may further be based on a cell load of the first network entity 401.

It will be appreciated that the first network entity 401 may further determine whether handover from the first network entity 401 to the second network entity 402 was necessary. It will be appreciated that the first network entity 401 may base this determination on a QoS indication received from the second network entity 402. This may be in accordance with the embodiments described in relation to FIGS. 2, 3a and 3b.

FIG. 5b shows the method steps that may be carried out by the second network entity 402 in accordance with embodiments.

At step 511, the user equipment 403 is handed over from the first network entity 401 to the second network entity 402. The second network entity 402 may receive a coverage quality measurement request from the first network element at step 512. The second network entity 402 may inform the user equipment 403 of the request. The user equipment 403 may carry out measurements of the signal quality and coverage provided by the first network entity 401 and report these measurements to the second network entity 402. These measurement reports may be received by the second network entity 402 at step 513.

The second network entity 402 may receive measurements from the user equipment 403 over a period of time. At the end of the period of time, the second network entity may provide information corresponding to the measurements to the first network entity 401. In some embodiments, the second network entity 402 may compare the measurements against a threshold. The information corresponding to the measurements may in these embodiments comprise an indication that one or more measurements fell below the threshold and/or did not fall below the threshold. In alternative or additional embodiments, the information corresponding to the measurements may indicate the lowest measurement or the measurement associated with the lowest quality coverage.

FIG. 6 shows an example of an apparatus that may be implemented in accordance with some embodiments. The apparatus of FIG. 6 may for example be the first network entity 201, the second network entity 202 or the user equipment 203. The apparatus of FIG. 6 comprises a processor 601 and at least one memory 602. The processor 601 and the least one memory 602 may be configured to carry out any of the method steps described above.

While the foregoing has described the first network entity as an eNodeB and the second network entity as an RNC, it will be appreciated that an eNodeB may comprise RNC functionality. It will also be appreciated that the user equipment may be handed over to a NodeB in being served by the RNC and communication with the RNC via the nodeB.

While the foregoing has described the first radio access network as an LTE radio access network and the second radio access network as URTAN, it will be appreciated that embodiments of the present application may be applicable to further or other networks.

The foregoing has described the second network entity 202 as monitoring the QoS metric measurements. It will be appreciated that the monitoring may comprise the second network entity 202 carrying out the measurements, for example based on information from the user equipment. In other embodiments the user equipment may carry out measurements and provide the measurements to the second network entity 202. The second network entity may have access to MDT measurements and the monitoring may comprise accessing MDT measurements. In other examples the monitoring may be carried out based on information from both the user equipment and the second network entity and the QoS metrics may be determined therefrom.

While the foregoing has described the handover being an inter-radio access technology handover, it will be appreciated that the handover in some embodiments may occur within the same radio access technology. In some embodiments, a handover may take place between different layers in a radio access network, for example between a pico cell and a macro cell. A pico cell may have a cell coverage for example within that of the macro cell and may provide additionally coverage in areas where coverage is a problem. For example the pico cell may be a repeater for providing coverage for an area of high traffic for example within a building in the macro cell's coverage area.

While the foregoing has described determination of whether a handover was unnecessary for purposes of optimising a network coverage, it will be appreciated that the determine may be made for other purposes. One example is the optimisation of a pico cell coverage within a macro cell. The handover need not be restricted to inter-RAT and in some embodiments the handover may occur within a same RAT.

It is also noted herein that while the above describes exemplifying embodiments, there are several variations and modifications which may be made to the disclosed solution without departing from the scope of the present invention.

In general, the various embodiments may be implemented in hardware or special purpose circuits, software, logic or any combination thereof. Some aspects of the embodiments may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Some embodiments may be implemented by computer software executable by a data processor of the mobile device, such as in the processor entity, or by hardware, or by a combination of software and hardware.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory.

Furthermore while some embodiments may have been described with entities associated with specific network implementation, for example in accordance with a 3GPP network, it will be appreciated that embodiments may be implemented in other networks and by network entities not restricted by a specific network implementation.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed, there is a further embodiment comprising a combination of one or more of any of the other embodiments previously discussed.

1. A method carried out by a first network entity comprising:
providing a request indication to a second network entity to monitor a quality of service provided to a user equipment handed over from the first network entity to the second network entity;
receiving a response indication of the quality of service provided to the user equipment by the second network entity; and
determining whether the handover was necessary based on the received response indication.

2. The method of claim 1, wherein the request indication to monitor the quality of service comprises an indication to measure a quality of service metric of a service provided to the user equipment by the second network entity, wherein the quality of service metric is a scheduled IP throughput.

3. (canceled)

4. The method of claim 1 wherein the first network entity operates in accordance with a first radio access technology and the second network entity operates in accordance with a second radio access technology.

5. The method of claim 1 wherein the response indication indicates at least one of: the quality of service is below a threshold; and the quality of service is above a threshold.

6. The method of claim 5 further comprising:
determining that the handover was unnecessary when the response indication indicates that the quality of service is below the threshold.

7. The method of claim 5 wherein the threshold corresponds to one of:
a quality of service that would have been provided to the user equipment if the user equipment had not been handed over; and
a minimum predefined quality of service.

8. The method of claim 1 further comprising:
estimating a quality of service corresponding to the quality of service that the first network entity would have provided to the user equipment if the user equipment had not been handed over.

9. The method of claim 8 further comprising:
providing the estimated quality of service to the second network entity.

10. The method of claim 8 further comprising:
comparing the response indication of the quality of service with the estimated quality of service to determine whether handover was necessary.

11. The method of claim 1 wherein the first network entity is a macro cell and the second network entity is a pico cell associated with the macro cell.

12. A method carried out by a second network entity comprising:
monitoring a quality of service provided to a user equipment handed over from a first network entity to the second network entity in response to a request indication from the first network entity;
generating a response indication of the quality of service provided to the user equipment by the second network entity; and
providing the response indication to the first network entity.

13. The method of claim 12, wherein the monitoring comprises measuring a quality of service metric of a service provided to the user equipment by the second network entity, wherein the quality of service metric is a scheduled IP throughput.

14. (canceled)

15. The method of claim 12 wherein the first network entity operates in accordance with a first radio access technology and the second network entity operates in accordance with a second radio access technology.

16. The method of claim 12 wherein generating the response indication of the quality of service comprises comparing the monitored quality of service to a threshold.

17. The method of claim 16 wherein generating the indication of the quality of service further comprises indicating at least one of: the quality of service is below a threshold; and the quality of service is above a threshold.

18. The method of claim 16 wherein the threshold corresponds to one of:
a quality of service that would have been provided to the user equipment if the user equipment had not been handed over; and
a minimum predefined quality of service.

19. The method of claim 12 further comprising:
receiving an estimated quality of service corresponding to the quality of service that the first network entity would have provided to the user equipment if the user equipment had not been handed over.

20. The method of claim 12 wherein generating an indication of the quality of service comprises determining a minimum monitored quality of service.

21. An apparatus comprising a processor and at least one memory, wherein the processor and the at least one memory are configured to cause the apparatus to carry out the steps of:
monitoring a quality of service provided to a user equipment handed over from a first network entity to the apparatus in response to a request indication from the first network entity;
generating a response indication of the quality of service provided to the user equipment by the apparatus; and
providing the response indication to the first network entity.

22. An apparatus comprising a processor and at least one memory, wherein the processor and the at least one memory are configured to cause the apparatus to carry out the steps of:
providing a request indication to a second network entity to monitor a quality of service provided to a user equipment handed over from the apparatus to the second network entity;
receiving a response indication of the quality of service provided to the user equipment by the second network entity; and
determining whether the handover was necessary based on the received response indication.

23. (canceled)

24. (canceled)
